(19) United States
(12) Patent Application Publication
(10) Pub. No.: US 2021/0395120 A1
(43) Pub. Date: Dec. 23, 2021

(54) Data-knowledge driven optimal control method for municipal wastewater treatment process

(71) Applicant: BEIJING UNIVERSITY OF TECHNOLOGY, Beijing (CN)

(72) Inventors: Hong-Gui Han, BEIJING (CN); Lin-lin Zhang, BEIJING (CN); Jun-Fei Qiao, BEIJING (CN)

(21) Appl. No.: 17/334,535

(22) Filed: May 28, 2021

(30) Foreign Application Priority Data
Apr. 27, 2020 (CN) 202010346100.5

(51) Int. Cl. C02F 3/00; C02F 3/30; G05B 19/042

(52) U.S. Cl. CPC C02F 3/006; C02F 3/30; G05B 19/042; G05B 2219/2605; C02F 2209/15; C02F 2209/22; C02F 2209/14; C02F 2209/006

(57) ABSTRACT

A data-knowledge driven multi-objective optimal control method for municipal wastewater treatment process belongs to the field of wastewater treatment. To balance the energy consumption and effluent quality, a data driven multi-objective optimization model, including energy consumption model and effluent quality model are established to obtain the nonlinear relationship along energy consumption, effluent quality and manipulated variables. Meanwhile, a multi-objective particle swarm optimization algorithm, based on evolutionary knowledge, is proposed to optimize the set-points of nitrate nitrogen and dissolved oxygen. Moreover, the proportional integral differential (PID) controller is designed to track the set-points. Then the effluent quality can be improved and the energy consumption can be reduced.

### CROSS-REFERENCE TO RELATED APPLICATION

This application claims the priority benefit of Chinese application serial No. 202010346100.5, filed on Apr. 27, 2020. The entirety of the above-mentioned patent application is hereby incorporated by reference herein and made a part of this specification.

### TECHNOLOGY AREA

In this patent, a data-knowledge driven optimal control method is designed for municipal wastewater treatment process. First, a data-driven multi-objective optimization model is established for municipal wastewater treatment process to describe the dynamic relationship among state variables, effluent quality and energy consumption. Second, a knowledge-based multi-objective particle swarm optimization is developed to obtain the optimal set-points of manipulated variables. Third, the proportional integral differential (PID) controller is designed to track the optimal set-points to improve the effluent quality and reduce the energy consumption. This patent can promote energy saving and emission reduction in municipal wastewater treatment process, which is of great significance.

### TECHNOLOGY BACKGROUND

In municipal wastewater treatment process, the organic matter is removed through a series of biochemical reactions, and then the treated water is discharged. Municipal wastewater treatment process is an indispensable part of water resources reuse, which plays an important role in saving water resources and maintaining sustainable development of water resources.

The mechanism of wastewater treatment process is complex, and nonlinear and strong coupling characteristics are obvious, which makes it difficult to optimize and control. Energy consumption and effluent quality are two conflicting and coupling optimization objectives in municipal wastewater treatment process. Therefore, it is an important research to balance the relationship between energy consumption and effluent quality. In the optimal control process, the energy consumption and effluent quality models are established. But due to the difference of municipal wastewater treatment plants and their environments, the mechanism model is difficult to determine. Therefore, the design of data-driven energy consumption and effluent quality models play an important role in accurately describing the optimization objectives of municipal wastewater treatment process. In addition, the optimal set-points of control variables depend on the optimization accuracy of the multi-objective optimization method. Therefore, designing a reasonable optimization method to optimize the control variables and tracking these optimal set-points can not only save energy and ensure the effluent quality to meet the discharge standard, but also play an important role in the stable and efficient operation of the wastewater treatment process.

In this patent, a data-knowledge driven optimal control is designed for municipal wastewater treatment process. A data driven multi-objective optimization model is applied to describe the dynamic relationship among state variables, effluent quality and energy consumption. A knowledge-based multi-objective particle swarm optimization is developed to obtain the optimal set-points of control variables. Meanwhile, the proportional integral differential (PID) controller is designed to track the optimal set-points to improve the effluent quality and reduce the energy consumption.

### SUMMARY OF THE PATENT

A data-knowledge driven optimal control method is designed for municipal wastewater treatment process in this patent. Its characteristic lies in obtaining the optimal set-points of manipulated variables and tracking these variables to improve effluent quality and reduce energy consumption. This patent adopts the following technical scheme and implementation steps:

(1) Establish data-driven multi-objective optimization model:

I. Taking energy consumption and effluent quality as objectives, a multi-objective optimization model is established for municipal wastewater treatment process.

min F(t)=[ƒ₁(t),ƒ₂(t)] (1)

where F(t) is the multi-objective optimization model of municipal wastewater treatment process at time t, ƒ₁(t) is the energy consumption at time t, ƒ₂(t) is the effluent quality at time t;

II. The data-driven energy consumption and effluent quality models are established as

$$\begin{matrix}{f}_{1} ( t ) = {W}_{10} ( t ) + {\sum }_{i = 1}^{{I}_{1}} {W}_{1 i} ( t ) {B}_{1 i} ( t ) & ( 2 ) \\ {f}_{2} ( t ) = {W}_{20} ( t ) + {\sum }_{i = 1}^{{I}_{2}} {W}_{2 i} ( t ) {B}_{2 i} ( t ) & ( 3 )\end{matrix}$$

where I₁ is the number of radial basis kernel functions of energy consumption model, I₁∈[3, 30], I₂ is the number of radial basis kernel functions of effluent quality model, I₂∈[3, 30], W₁₀(t) is the output offset of energy consumption model, W₂₀(t) is the output offset of effluent quality model, W₁ᵢ(t) is the weight of the ith radial basis kernel function in energy consumption model, W₂ᵢ(t) is the weight of the ith radial basis kernel function in effluent quality model, B₁ᵢ(t) is the ith radial basis kernel function related to energy consumption model, B₂ᵢ(t) is the ith radial basis kernel function related to effluent quality model.

$$\begin{matrix}{B}_{1 i} ( t ) = {e}^{- {‖ s ( t ) - {c}_{1 i} ( t ) ‖}^{2} / 2 {{σ}_{1 i} ( t )}^{2}} & ( 4 ) \\ {B}_{2 i} ( t ) = {e}^{- {‖ s ( t ) - {c}_{2 i} ( t ) ‖}^{2} / 2 {{σ}_{2 i} ( t )}^{2}} & ( 5 )\end{matrix}$$

where s(t)=[S_{NO}(t), S_{O}(t), MLSS(t), S_{NH}(t)] is the input vector, S_{NO}(t) is the concentration of nitrate nitrogen in anaerobic final stage at time t, S_{NO}(t)∈[0.2 mg/L, 2 mg/L], S_{O}(t) is the concentration of dissolved oxygen in aerobic end stage at time t, S_{O}(t)∈[0.4 mg/L, 3 mg/L], MLSS(t) is the effluent concentration of mixed liquor suspended solids at time t, MLSS(t)∈[0 mg/L, 100 mg/L], S_{NH}(t) is the effluent concentration of ammonia nitrogen at time t, S_{NH}(t)∈[0 mg/L, 4 mg/L], c₁ᵢ(t) is the center of the ith radial basis function in energy consumption model, all the variables of c₁ᵢ(t) are limited in [−1, 1], c₂ᵢ(t) is the center of the ith radial basis function in effluent quality model, all the variables of c₂ᵢ(t) are limited in [−1, 1], σ₁ᵢ(t) is the width of the ith radial basis function in the energy consumption model, σ₁ᵢ(t)∈[0, 3], σ₂ᵢ(t) is the width of the ith radial basis function in the effluent quality model, σ₁ᵢ(t)∈[0, 3];

(2) Design multi-objective particle swarm optimization based on evolutionary knowledge:

1) The controllable variables S_{NO} and S_{O} of municipal wastewater treatment process are used as the position variables of multi-objective particle swarm optimization. The population size of multi-objective particle swarm optimization is set to N, N∈[10, 100]. The maximum iteration time of multi-objective particle swarm optimization is set to K, K∈[50, 200]. The iteration time of population is set to k, k∈[1, K]. The number of iterations of particle information is set to k₀, k₀∈[2, 10];

2) Initialize the population: the population with N particles is randomly generated. The objective values are obtained by formula (1). The personal best position is

pₙ(1)=xₙ(1) (6)

where pₙ(1) is the personal best position of the nth particle in the first iteration, xₙ(1)=[x_{n,1}(1), x_{n,2}(1)] is the position of the nth particle in the first iteration, x_{n,1}(1) is the first dimensional position of the nth particle in the first iteration, x_{n,1}(1)∈[0.2 mg/L, 2 mg/L], x_{n,2}(1) is the second dimensional position of the nth particle in the first iteration, x_{n,2}(1)∈[0.4 mg/L, 3 mg/L];

Establish the archive A(1): the archive is obtained by comparing the objectives between particles. When both objectives of a particle are less than or equal to the corresponding objectives of other particles, and at least one objective is smaller than the corresponding objective of other particles, then this particle is called the non-dominated solution. By comparing the objectives of particle, the non-dominated solutions are stored in the archive;

The diversity distribution is calculated by

$$D {S}_{n} ( 1 ) = {\sum }_{m = 1}^{M} {\sum }_{j = 1}^{N} \vert ( {f}_{n , m} ( 1 ) - {f}_{j , m} ( 1 ) \vert \text{/} N \qquad ( 7 )$$

where DSₙ(1) is the diversity distribution of the nth particle in the first iteration, ƒ_{n,m}(1) is the mth objective value of the nth particle in the first iteration, |⋅| represents absolute value;

3) The evolutionary process of population

I. Enter the next iteration, that is, increase the number of iterations by 1. The convergence distribution and diversity distribution of each particle are recorded in the evolutionary process:

$$\begin{matrix}C {S}_{n} ( k ) = \{ \begin{matrix}{\sum }_{m = 1}^{M} ( {f}_{n , m} ( k - 1 ) - {f}_{n , m} ( k ) ) , & if {x}_{n} ( k ) < {x}_{n} ( k - 1 ) \\ 0 , & otherwh ise\end{matrix} & ( 8 ) \\ {DS}_{n} ( k ) = {\sum }_{m = 1}^{M} {\sum }_{j = 1}^{N} \vert ( {f}_{n , m} ( k ) - {f}_{j , m} ( k ) \vert \text{/} N & ( 9 )\end{matrix}$$

where CSₙ(k) is the convergence distribution of the nth particle in the kth iteration, ƒ_{n,m}(k) is the mth objective value of the nth particle in the kth iteration, m∈[1, M], M=2, xₙ(k) is the position vector of the nth particle, DSₙ(k) is the diversity distribution of the nth particle in the kth iteration, |⋅| represents absolute value;

II. The convergence and diversity indexes of individual and population are established by using distribution knowledge, in which the distribution knowledge consists of historical distributions of particles.

$$\begin{matrix}{IC}_{n} ( k ) = {\sum }_{u = k - {k}_{0}}^{k} {e}^{- \frac{{CS}_{n} ( k )}{k - u + 1}} & ( 10 ) \\ P C ( k ) = {\sum }_{n = 1}^{N} {IC}_{n} ( k ) & ( 11 ) \\ {ID}_{n} ( k ) = {\sum }_{u = k - {k}_{0}}^{k} {e}^{- \frac{D {S}_{n} ( k )}{k - u + 1}} & ( 12 ) \\ PD ( k ) = {\sum }_{n = 1}^{N} {ID}_{n} ( k ) & ( 13 )\end{matrix}$$

where ICₙ(k) is the individual convergence of the nth particle in the kth iteration, PC(k) is the population convergence in the kth iteration, IDₙ(k) is the individual diversity of the nth particle in the kth iteration, PD(k) is the population diversity in the kth iteration, u∈[k−k₀, k] is the iteration times;

III. Select the evolutionary strategy of population:

Case 1: When PC(k)>PC(k−1) and PD(k)>PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{i,d}(k)) (14)

x_{n,d}(k+1)=x_{n,d}(k)+v_{n,d}(k+1) (15)

where ω is the inertia weight selected in [0.5, 0.9] randomly, v_{n,d}(k) is the d-dimensional velocity of the nth particle in the kth iteration, x_{n,d}(k) is the d-dimensional position of the nth particle in the kth iteration, p_{n,d}(k) is the d-dimensional personal best position of the nth particle in the kth iteration, g_{d}(k) is the d-dimensional position of the population in the kth iteration, r₁ and r₂ are the random value distributed in [0, 1], c₁ is the acceleration factor of personal best solution, selected in [1.5, 2.5] randomly, c₂ is the acceleration factor of global best solution, selected in [1.5, 2.5] randomly.

Case 2: When PC(k)<PC(k−1) and PD(k)>PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{n,d}(k))+c₃r₃C_{d}(k) (16)

x_{n,d}(k+1)=x_{n,d}(k)+v_{n,d}(k+1) (17)

where r₃ is the random value distributed in [0, 1], c₃ is the acceleration factor related to convergence direction, selected in [0.3, 0.5] randomly, C_{d}(k) is the d-dimensional flight direction of particles with maximum convergence in the population.

Case 3: When PC(k)>PC(k−1) and PD(k)<PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{n,d}(k))+c₄r₄D_{d}(k) (18)

x_{n,d}(k+1)=x_{n,d}(k)+v_{n,d}(k+1) (19)

where r₄ is the random value distributed in [0, 1], c₄ is the acceleration factor related to diversity direction, selected in [0.3, 0.5] randomly, Da(k) is the d-dimensional flight direction of particles with maximum diversity in the population.

Case 4: When PC(k)<PC(k−1) and PD(k)<PD(k−1), the velocity and position of particle are updated by

v_{n,d}(k+1)=ωv_{n,d}(k)+c₁r₁(p_{n,d}(k)−x_{n,d}(k)−x_{n,d}(k))+c₂r₂(g_{d}(k)−x_{i,d}(k))+½(c₃r₃C_{d}(k)+c₄r₄D_{d}(k)) (20)

x_{n,d}(k+1)=x_{n,d}(k)+v_{n,d}(k+1) (21)

Case 5: When PC(k)=PC(k−1) or PD(k)=PD(k−1), the velocity and position of particle are updated by

$$\begin{matrix}{v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) & ( 22 ) \\ {x}_{n , d} ( k + 1 ) = \{ \begin{matrix}{x}_{d , min} + ( {x}_{d , max} - {x}_{d , min} ) \times U ( 0 , 1 ) , & {r}_{5} \leq {p}_{b} \\ {x}_{n , d} ( k ) , & {r}_{5} > {p}_{b}\end{matrix} & ( 23 )\end{matrix}$$

where U(0, 1) is a random value between 0 and 1 which obeys uniform distribution, x_{d,min} is the minimum boundary value of d-dimensional position, x_{d,max} is the maximum boundary value of d-dimensional position. When d=1, x_{1,min}=0.2 mg/L, x_{1,max}=2 mg/L. When d=2, x_{2,min}=0.4 mg/L, x_{2,max}=3 mg/L. r₅ is the random value distributed in [0, 1], p_{b} is the mutation probability, which is described as

$${p}_{b} = 0.5 - 0.5 \times \frac{k}{K} \qquad ( 24 )$$

IV. The population in the kth iteration is combined with the archive A(k−1) to obtain J(k), and then the non-dominated solutions are selected from J(k) to establish A(k);

V. If k is greater than or equal to K, go to step VI. If k is less than K, go to step I;

VI. In the archive A(K), a non-dominated solution is randomly selected as the optimal set-point a*(t)=aₕ(K), aₕ(K)=[S_{NO}*(K), S_{O}*(K)], where S_{NO}*(K) is the optimal set-point of S_{NO}, S_{O}*(K) is the optimal set-point of S_{O}. Then, the optimal set-points are saved;

(3) Track the optimal set-points S_{NO}*(K) and S_{O}*(K):

PID controller is designed to track the optimal set-points S_{NO}*(K) and S_{O}*(K). The expression of PID controller is

$$\begin{matrix}Δ z ( t ) = {K}_{p} [ e ( t ) + {H}_{l} {\int }_{0}^{t} e ( t ) d t + {H}_{d} \frac{d e ( t )}{d t} ] & ( 25 ) \\ {K}_{p} = [ \begin{matrix}10000 & 0 \\ 0 & 20\end{matrix} ] & ( 26 ) \\ {H}_{l} = [ \begin{matrix}3000 & 0 \\ 0 & 5\end{matrix} ] & ( 27 ) \\ {H}_{d} = [ \begin{matrix}100 & 0 \\ 0 & 1\end{matrix} ] & ( 28 )\end{matrix}$$

where Δz(t)=[ΔQₐ(t), ΔK_{La}5(t)]⁻¹ is the manipulated variable matrix, ΔQₐ(t) is the change of internal circulation flow in wastewater treatment process, ΔK_{La}5(t) is the change of oxygen transfer coefficient in the fifth zone of biochemical reactor, Kₚ is the proportional coefficient matrix, Hₗ is the integral coefficient matrix, and H_{d} is the differential coefficient matrix. e(t)=y*(t)^{T}−y(t)^{T} is the control error, y*(t)=[S_{NO}*(t), S_{O}*(t)] is the optimal set-point matrix at time t, y(t)=[S_{NO}(t), S_{O}(t)] is the actual output matrix.

(4) The inputs of data-knowledge driven optimal control system of municipal wastewater treatment process are the change of internal circulation flow ΔQₐ(t) and the change of oxygen transfer coefficient in the fifth zone of biochemical reactor ΔK_{La}5(t). The optimal set-points of S_{NO} and S_{O} in municipal wastewater treatment process are tracked and controlled.

The novelties of this patent contain:

(1) In order to improve the effluent quality and reduce the energy consumption, a data-knowledge driven optimal control is proposed in this patent. The multi-objective optimization model, which consists of energy consumption model and effluent quality model, are established by data driven method. The multi-objective particle swarm optimization algorithm, based on evolutionary knowledge, is developed to optimize the multi-objective optimization model to obtain the optimal set-points of control variables. Finally, the optimal set-points are tracked by PID controller. The data-knowledge driven optimal control method can not only improve the effluent quality and reduce the energy consumption, but also make the municipal wastewater treatment process has high stability.

Attention: It is particularly noted that the invention is only for convenience of description. The energy consumption and effluent quality model is established by using the data driven model with radial basis kernel function. The multi-objective particle swarm optimization method, based on evolutionary knowledge, is used to optimize the concentration of dissolved oxygen and the concentration of nitrate nitrogen. Other data driven modeling algorithms and knowledge-based optimization algorithms with the same principle should belong to the scope of the invention.

### DESCRIPTION OF DRAWINGS

FIG. 1 shows the framework of data-knowledge driven optimal control method.

FIG. 2 shows the tracking result of nitrate nitrogen for the optimal control method.

FIG. 3 shows the tracking error of nitrate nitrogen for the optimal control method.

FIG. 4 shows the tracking result of dissolved oxygen for the optimal control method.

FIG. 5 shows the tracking error of dissolved oxygen for the optimal control method.

### DETAILED DESCRIPTION OF THE INVENTION

A data-knowledge driven optimal control method is designed for municipal wastewater treatment process in this patent. Its characteristic lies in obtaining the optimal set-points of manipulated variables and tracking these variables to improve effluent quality and reduce energy consumption. This patent adopts the following technical scheme and implementation steps:
(1) Establish data-driven multi-objective optimization model:

I. Taking energy consumption and effluent quality as objectives, a multi-objective optimization model is established for municipal wastewater treatment process.

min F(t)=[ƒ₁(t),ƒ₂(t)] (1)

where F(t) is the multi-objective optimization model of municipal wastewater treatment process at time t, ƒ₁(t) is the energy consumption at time t, ƒ₂(t) is the effluent quality at time t;

II. The data-driven energy consumption and effluent quality models are established as

$$\begin{matrix}{f}_{1} ( t ) = {W}_{10} ( t ) + {\sum }_{i = 1}^{{I}_{1}} {W}_{1 i} ( t ) {B}_{1 i} ( t ) & ( 2 ) \\ {f}_{2} ( t ) = {W}_{20} ( t ) + {\sum }_{i = 1}^{{I}_{2}} {W}_{2 i} ( t ) {B}_{2 i} ( t ) & ( 3 )\end{matrix}$$

where I₁=10 is the number of radial basis kernel functions of energy consumption model, I₂=10 is the number of radial basis kernel functions of effluent quality model, W₁₀(t)=−1.20 is the output offset of energy consumption model, W₁₀(0)=−1.20, W₂₀(t) is the output offset of effluent quality model, W₂₀(0)=0.34, W₁ᵢ(t) is the weight of the ith radial basis kernel function in energy consumption model, W₁ᵢ(0)=−0.78, W₂ᵢ(t) is the weight of the ith radial basis kernel function in effluent quality model, W₂ᵢ(0)=1.62, B₁ᵢ(t) is the ith radial basis kernel function related to energy consumption model, B₂ᵢ(t) is the ith radial basis kernel function related to effluent quality model.

$$\begin{matrix}{B}_{1 i} ( t ) = {e}^{- {‖ s ( t ) - {c}_{1 i} ( t ) ‖}^{2} / 2 {{σ}_{1 i} ( t )}^{2}} & ( 4 ) \\ {B}_{2 i} ( t ) = {e}^{- {‖ s ( t ) - {c}_{2 i} ( t ) ‖}^{2} / 2 {{σ}_{2 i} ( t )}^{2}} & ( 5 )\end{matrix}$$

where s(t)=[S_{NO}(t), S_{O}(t), MLSS(t), S_{NH}(t)] is the input vector, s(0)=[1, 1.5, 15, 2.3], S_{NO}(t) is the concentration of nitrate nitrogen in anaerobic final stage at time t, S_{NO}(t)∈[0.2 mg/L, 2 mg/L], S_{O}(t) is the concentration of dissolved oxygen in aerobic end stage at time t, S_{O}(t)∈[0.4 mg/L, 3 mg/L], MLSS(t) is the effluent concentration of mixed liquor suspended solids at time t, MLSS(t)∈[0 mg/L, 100 mg/L], S_{NH}(t) is the effluent concentration of ammonia nitrogen at time t, S_{NH}(t)∈[0 mg/L, 4 mg/L], c₁ᵢ(t) is the center of the ith radial basis function in energy consumption model, c₁ᵢ(0)=[0.76, 0.45, 0.21, −0.33], c₂ᵢ(t) is the center of the ith radial basis function in effluent quality model, c₂ᵢ(0)=[0.82, 0.67, −0.29, 0.85], σ₁ᵢ(t) is the width of the ith radial basis function in the energy consumption model, σ₂ᵢ(0)=0.62, σ₂ᵢ(t) is the width of the ith radial basis function in the effluent quality model, σ₂ᵢ(0)=1.72;

(2) Design multi-objective particle swarm optimization based on evolutionary knowledge:

1) The controllable variables S_{NO} and S_{O} of municipal wastewater treatment process are used as the position variables of multi-objective particle swarm optimization. The population size of multi-objective particle swarm optimization is set to N, N=20. The maximum iteration time of multi-objective particle swarm optimization is set to K, K=100. The iteration time of population is set to k, k∈[1, K]. The number of iterations of particle information is set to k₀=4;

2) Initialize the population: the population with N particles is randomly generated. The objective values are obtained by formula (1). The personal best position is

pₙ(1)=xₙ(1) (6)

where pₙ(1) is the personal best position of the nth particle in the first iteration, xₙ(1)=[x_{n,1}(1), x_{n,2}(1)] is the position of the nth particle in the first iteration, x_{n,1}(1) is the first dimensional position of the nth particle in the first iteration, x_{n,1}(1)∈[0.2 mg/L, 2 mg/L], x_{n,2}(1) is the second dimensional position of the nth particle in the first iteration, x_{n,2}(1)∈[0.4 mg/L, 3 mg/L];

Establish the archive A(1): the archive is obtained by comparing the objectives between particles. When both objectives of a particle are less than or equal to the corresponding objectives of other particles, and at least one objective is smaller than the corresponding objective of other particles, then this particle is called the non-dominated solution. By comparing the objectives of particle, the non-dominated solutions are stored in the archive;

The diversity distribution is calculated by

$$D {S}_{n} ( 1 ) = {\sum }_{m = 1}^{M} {\sum }_{j = 1}^{N} \vert ( {f}_{n , m} ( 1 ) - {f}_{j , m} ( 1 ) \vert \text{/} N \qquad ( 7 )$$

where DSₙ(1) is the diversity distribution of the nth particle in the first iteration, ƒ_{n,m}(1) is the mth objective value of the nth particle in the first iteration, |⋅| represents absolute value;

3) The evolutionary process of population

I. Enter the next iteration, that is, increase the number of iterations by 1. The convergence distribution and diversity distribution of each particle are recorded in the evolutionary process:

$$\begin{matrix}C {S}_{n} ( k ) = \{ \begin{matrix}{\sum }_{m = 1}^{M} ( {f}_{n , m} ( k - 1 ) - {f}_{n , m} ( k ) ) , & if {x}_{n} ( k ) < {x}_{n} ( k - 1 ) \\ 0 , & otherwhise\end{matrix} & ( 8 ) \\ {DS}_{n} ( k ) = {\sum }_{m = 1}^{M} {\sum }_{j = 1}^{N} \vert ( {f}_{n , m} ( k ) - {f}_{j , m} ( k ) \vert \text{/} N & ( 9 )\end{matrix}$$

where CSₙ(k) is the convergence distribution of the nth particle in the kth iteration, ƒ_{n,m}(k) is the mth objective value of the nth particle in the kth iteration, m∈[1, M], M=2, xₙ(k) is the position vector of the nth particle, DSₙ(k) is the diversity distribution of the nth particle in the kth iteration, |⋅| represents absolute value;

II. The convergence and diversity indexes of individual and population are established by using distribution knowledge, in which the distribution knowledge consists of historical distributions of particles.

$$\begin{matrix}{IC}_{n} ( k ) = {\sum }_{u = k - {k}_{0}}^{k} {e}^{- \frac{C {S}_{n} ( k )}{k - u + 1}} & ( 10 ) \\ PC ( k ) = {\sum }_{n = 1}^{N} {IC}_{n} ( k ) & ( 11 ) \\ {I D}_{n} ( k ) = {\sum }_{u = k - {k}_{0}}^{k} {e}^{- \frac{D {S}_{n} ( k )}{k - u + 1}} & ( 12 ) \\ PD ( k ) = {\sum }_{n = 1}^{N} {ID}_{n} ( k ) & ( 13 )\end{matrix}$$

where ICₙ(k) is the individual convergence of the nth particle in the kth iteration, PC(k) is the population convergence in the kth iteration, IDₙ(k) is the individual diversity of the nth particle in the kth iteration, PD(k) is the population diversity in the kth iteration, u∈[k−k₀, k] is the iteration times;

III. Select the evolutionary strategy of population:

Case 1: When PC(k)>PC(k−1) and PD(k)>PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−(k)) (14)

x_{n,d}(k+1)=x_{n,d}(k)+v_{n,d}(k+1) (15)

where ω is the inertia weight selected in [0.5, 0.9] randomly, v_{n,d}(k) is the d-dimensional velocity of the nth particle in the kth iteration, x_{n,d}(k) is the d-dimensional position of the nth particle in the kth iteration, p_{n,d}(k) is the d-dimensional personal best position of the nth particle in the kth iteration, g_{d}(k) is the d-dimensional position of the population in the kth iteration, r₁ and r₂ are the random value distributed in [0, 1], c₁ is the acceleration factor of personal best solution, selected in [1.5, 2.5] randomly, c₂ is the acceleration factor of global best solution, selected in [1.5, 2.5] randomly.

Case 2: When PC(k)<PC(k−1) and PD(k)>PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{i,d}(k))+c₃r₃C_{d}(k) (16)

x_{n,d}(k+1)=x_{n,d}(k)+v_{n,d}(k+1) (17)

where r₃ is the random value distributed in [0, 1], c₃ is the acceleration factor related to convergence direction, selected in [0.3, 0.5] randomly, C_{d}(k) is the d-dimensional flight direction of particles with maximum convergence in the population.

Case 3: When PC(k)>PC(k−1) and PD(k)<PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{i,d}(k))+c₄r₄D_{d}(k) (18)

x_{n,d}(k+1)=x_{n,d}(k)+v_{n,d}(k+1) (19)

where r₄ is the random value distributed in [0, 1], c₄ is the acceleration factor related to diversity direction, selected in [0.3, 0.5] randomly, Da(k) is the d-dimensional flight direction of particles with maximum diversity in the population.

Case 4: When PC(k)<PC(k−1) and PD(k)<PD(k−1), the velocity and position of particle are updated by

v_{n,d}(k+1)=ωv_{n,d}(k)+c₁r₁(p_{n,d}(k)−x_{n,d}(k))+c₂r₂(g_{d}(k)−x_{i,d}(k))+½(c₃r₃C_{d}(k)+c₄r_{d}D_{d}(k)) (20)

x_{n,d}(k+1)=x_{n,d}(k)+v_{n,d}(k+1) (21)

Case 5: When PC(k)=PC(k−1) or PD(k)=PD(k−1), the velocity and position of particle are updated by

$$\begin{matrix}{v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) & ( 22 ) \\ {x}_{n , d} ( k + 1 ) = \{ \begin{matrix}{x}_{d , min} + ( {x}_{d , max} - {x}_{d , min} ) \times U ( 0 , 1 ) , & {r}_{5} \leq {p}_{b} \\ {x}_{n , d} ( k ) , & {r}_{5} > {p}_{b}\end{matrix} & ( 23 )\end{matrix}$$

where U(0, 1) is a random value between 0 and 1 which obeys uniform distribution, x_{d,min} is the minimum boundary value of d-dimensional position, x_{d,max} is the maximum boundary value of d-dimensional position. When d=1, x_{1,min}=0.2 mg/L, x_{1,max}=2 mg/L. When d=2, x_{2,min}=0.4 mg/L, x_{2,max}=3 mg/L. r₅ is the random value distributed in [0, 1], p_{b} is the mutation probability, which is described as

$${p}_{b} = 0.5 - 0.5 \times \frac{k}{K} \qquad ( 24 )$$

IV. The population in the kth iteration is combined with the archive A(k−1) to obtain J(k), and then the non-dominated solutions are selected from J(k) to establish A(k);

V. If k is greater than or equal to K, go to step VI. If k is less than K, go to step I;

VI. In the archive A(K), a non-dominated solution is randomly selected as the optimal set-point a*(t)=ab(K), ab(K)=[S_{NO}*(K), S o*(K)], where S_{NO}*(K) is the optimal set-point of S_{NO}, S_{O}*(K) is the optimal set-point of S_{O}. Then, the optimal set-points are saved;

(3) Track the optimal set-points S_{NO}*(K) and S_{O}*(K):

PID controller is designed to track the optimal set-points S_{NO}*(K) and S_{O}*(K). The expression of PID controller is

$$\begin{matrix}Δ z ( t ) = {K}_{p} [ e ( t ) + {H}_{l} {\int }_{0}^{t} e ( t ) d t + {H}_{d} \frac{d e ( t )}{d t} ] & ( 25 ) \\ {K}_{p} = [ \begin{matrix}10000 & 0 \\ 0 & 20\end{matrix} ] & ( 26 ) \\ {H}_{l} = [ \begin{matrix}3000 & 0 \\ 0 & 5\end{matrix} ] & ( 27 ) \\ {H}_{d} = [ \begin{matrix}100 & 0 \\ 0 & 1\end{matrix} ] & ( 28 )\end{matrix}$$

where Δz(t)=[ΔQₐ(t), ΔK_{La}5(t)]^{T} is the manipulated variable matrix, ΔQₐ(t) is the change of internal circulation flow in wastewater treatment process, ΔK_{La}5(t) is the change of oxygen transfer coefficient in the fifth zone of biochemical reactor, Kₚ is the proportional coefficient matrix, Hₗ is the integral coefficient matrix, and Ha is the differential coefficient matrix. e(t)=y*(t)^{T}−y(t)^{T} is the control error, y*(t)=[S_{NO}*(t), S_{O}*(t)] is the optimal set-point matrix at time t, y(t)=[S_{NO}(t), S_{O}(t)] is the actual output matrix.

(4) The inputs of data-knowledge driven optimal control system of municipal wastewater treatment process are the change of internal circulation flow ΔQₐ(t) and the change of oxygen transfer coefficient in the fifth zone of biochemical reactor ΔK_{La}5(t). The optimal set-points of S_{NO} and S_{O} in municipal wastewater treatment process are tracked and controlled.

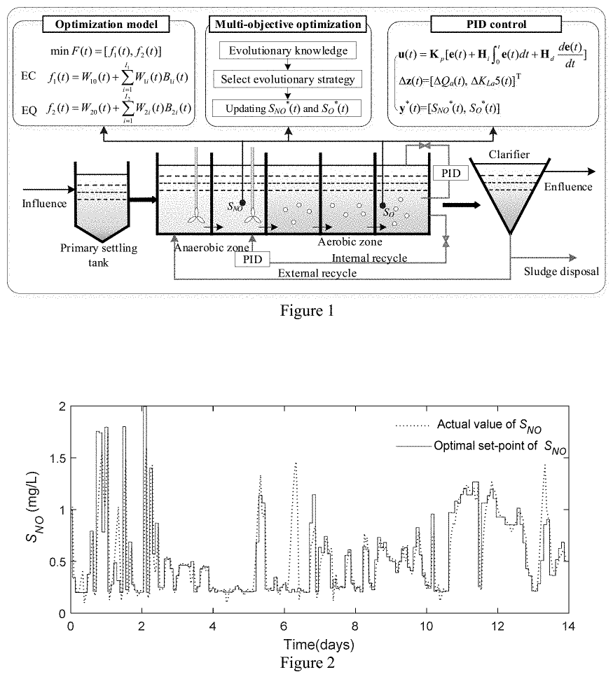

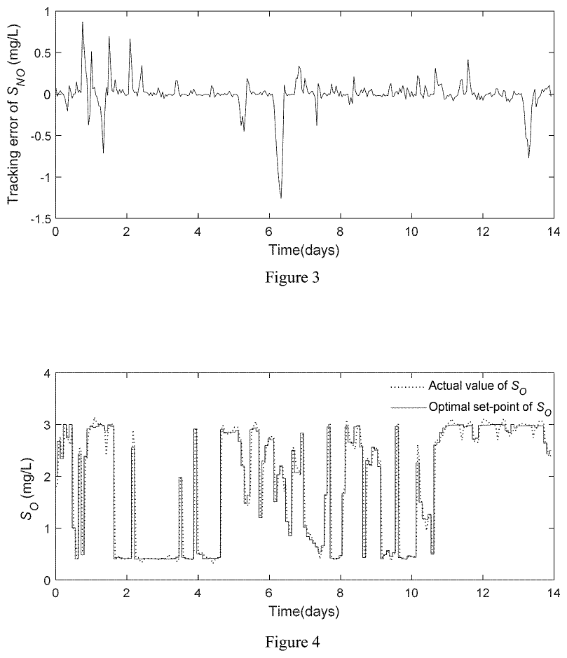

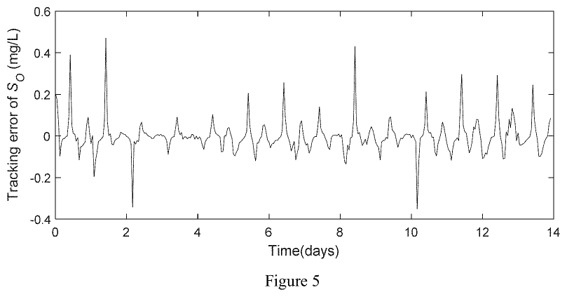

The framework of data-knowledge driven optimal control method is shown in FIG. 1. The tracking result of nitrate nitrogen is shown in FIG. 2. The solid line is the control output and the dotted line is the actual output. X axis shows the time, Y axis shows the concentration of nitrate nitrogen. The tracking error of nitrate nitrogen is shown in FIG. 3. X axis shows the time, Y axis shows the error of nitrate nitrogen. The tracking result of dissolved oxygen is shown in FIG. 4. The solid line is the control output and the dotted line is the actual output. X axis shows the time, Y axis shows the concentration of dissolved oxygen. The tracking error of dissolved oxygen is shown in FIG. 5. X axis shows the time, Y axis shows the error of dissolved oxygen.

What is claimed is:

1. A data-knowledge driven optimal control method of municipal wastewater treatment process, comprising obtaining optimal set-points of manipulated variables and tracking the manipulated variables to improve effluent quality and reduce energy consumption, the method comprising the following technical scheme and implementation steps:
(1) establish data-driven multi-objective optimization model:
I. taking energy consumption and effluent quality as objectives, a multi-objective optimization model is established for municipal wastewater treatment process.
min F(t)=[ƒ₁(t),ƒ₂(t)] (1)
where F(t) is the multi-objective optimization model of municipal wastewater treatment process at time t, ƒ₁(t) is energy consumption at time t, ƒ₂(t) is effluent quality at time t;
II. data-driven energy consumption and effluent quality models are established as
$$\begin{matrix}{f}_{1} ( t ) = {W}_{10} ( t ) + {\sum }_{i = 1}^{{I}_{1}} {W}_{1 i} ( t ) {B}_{1 i} ( t ) & ( 2 ) \\ {f}_{2} ( t ) = {W}_{20} ( t ) + {\sum }_{i = 1}^{{I}_{2}} {W}_{2 i} ( t ) {B}_{2 i} ( t ) & ( 3 )\end{matrix}$$
where I₁ is a number of radial basis kernel functions of the energy consumption model, I₁∈[3, 30], I₂ is a number of radial basis kernel functions of the effluent quality model, I₂∈[3, 30], W₁₀(t) is an output offset of the energy consumption model, W₂₀(t) is an output offset of the effluent quality model, W₁ᵢ(t) is a weight of ith radial basis kernel function in the energy consumption model, W₂ᵢ(t) is a weight of ith radial basis kernel function in the effluent quality model, B₁ᵢ(t) is ith radial basis kernel function related to the energy consumption model, B₂ᵢ(t) is ith radial basis kernel function related to the effluent quality model.
$$\begin{matrix}{B}_{1 i} ( t ) = {e}^{- {‖ s ( t ) - {c}_{1 i} ( t ) ‖}^{2} / 2 {{σ}_{1 i} ( t )}^{2}} & ( 4 ) \\ {B}_{2 i} ( t ) = {e}^{- {‖ s ( t ) - {c}_{2 i} ( t ) ‖}^{2} / 2 {{σ}_{2 i} ( t )}^{2}} & ( 5 )\end{matrix}$$
where s(t)=[S_{NO}(t), S_{O}(t), MLSS(t), S_{NH}(t)] is an input vector, S_{NO}(t) is a concentration of nitrate nitrogen in anaerobic final stage at time t, S_{NO}(t)∈[0.2 mg/L, 2 mg/L], S_{O}(t) is a concentration of dissolved oxygen in aerobic end stage at time t, S_{O}(t)∈[0.4 mg/L, 3 mg/L], MLSS(t) is an effluent concentration of mixed liquor suspended solids at time t, MLSS(t)∈[0 mg/L, 100 mg/L], S_{NH}(t) is an effluent concentration of ammonia nitrogen at time t, S_{NH}(t)∈[0 mg/L, 4 mg/L], c₁ᵢ(t) is a center of ith radial basis function in the energy consumption model, all variables of c₁ᵢ(t) are limited in [−1, 1], c₂ᵢ(t) is a center of ith radial basis function in the effluent quality model, all variables of c₂ᵢ(t) are limited in [−1, 1], σ₁ᵢ(t) is a width of ith radial basis function in the energy consumption model, σ₁ᵢ(t)∈[0, 3], σ₂ᵢ(t) is a width of ith radial basis function in the effluent quality model, σ₂ᵢ(t)∈[0, 3];
(2) design multi-objective particle swarm optimization based on evolutionary knowledge:
1) controllable variables S_{NO} and S_{O} of municipal wastewater treatment process are used as position variables of multi-objective particle swarm optimization; population size of multi-objective particle swarm optimization is set to N, N∈[10, 100]; maximum iteration time of multi-objective particle swarm optimization is set to K, K∈[50, 200]; iteration time of population is set to k, k∈[1, K]; a number of iterations of particle information is set to k₀, k₀∈[2, 10];
2) initialize population: a population with N particles is randomly generated; objective values are obtained by formula (1); a personal best position is
pₙ(1)=xₙ(1) (6)
where pₙ(1) is the personal best position of nth particle in a first iteration, xₙ(1)=[x_{n,1}(1), x_{n,2}(1)] is a position of the nth particle in the first iteration, x_{n,1}(1) is a first dimensional position of the nth particle in the first iteration, x_{n,1}(1)∈[0.2 mg/L, 2 mg/L], x_{n,2}(1) is a second dimensional position of the nth particle in the first iteration, x_{n,2}(1)∈[0.4 mg/L, 3 mg/L];
establish archive A(1): an archive is obtained by comparing objectives between particles; when both objectives of a particle are less than or equal to corresponding objectives of other particles, and at least one objective is smaller than the corresponding objective of other particles, then this particle is called a non-dominated solution; by comparing the objectives of particle, the non-dominated solutions are stored in the archive;
a diversity distribution is calculated by
$$D {S}_{n} ( 1 ) = {\sum }_{m = 1}^{M} {\sum }_{j = 1}^{N} \vert ( {f}_{n , m} ( 1 ) - {f}_{j , m} ( 1 ) \vert \text{/} N \qquad ( 7 )$$
where DSₙ(1) is a diversity distribution of the nth particle in the first iteration, ƒ_{n,m}(1) is mth objective value of the nth particle in the first iteration, |⋅| represents absolute value;
3) evolutionary process of population
I. enter next iteration by increasing the number of iterations by 1; a convergence distribution and a diversity distribution of each particle are recorded in the evolutionary process of population:
$$\begin{matrix}C {S}_{n} ( k ) = \{ \begin{matrix}{\sum }_{m = 1}^{M} ( {f}_{n , m} ( k - 1 ) - {f}_{n , m} ( k ) ) , & if {x}_{n} ( k ) < {x}_{n} ( k - 1 ) \\ 0 , & otherwhise\end{matrix} & ( 8 ) \\ {DS}_{n} ( k ) = {\sum }_{m = 1}^{M} {\sum }_{j = 1}^{N} \vert ( {f}_{n , m} ( k ) - {f}_{j , m} ( k ) \vert \text{/} N & ( 9 )\end{matrix}$$
where CSₙ(k) is a convergence distribution of nth particle in kth iteration, ƒ_{n,m}(k) is mth objective value of the nth particle in the kth iteration, m∈[1, M], M=2, xₙ(k) is a position vector of the nth particle, DSₙ(k) is a diversity distribution of the nth particle in the kth iteration, |⋅| represents absolute value;
II. convergence and diversity indexes of individual and population are established by using distribution knowledge, in which the distribution knowledge includes historical distributions of particles.
$$\begin{matrix}{IC}_{n} ( k ) = {\sum }_{u = k - {k}_{0}}^{k} {e}^{- \frac{C {S}_{n} ( k )}{k - u + 1}} & ( 10 ) \\ PC ( k ) = {\sum }_{n = 1}^{N} {IC}_{n} ( k ) & ( 11 ) \\ {I D}_{n} ( k ) = {\sum }_{u = k - {k}_{0}}^{k} {e}^{- \frac{D {S}_{n} ( k )}{k - u + 1}} & ( 12 ) \\ PD ( k ) = {\sum }_{n = 1}^{N} {ID}_{n} ( k ) & ( 13 )\end{matrix}$$
where ICₙ(k) is individual convergence of the nth particle in the kth iteration, PC(k) is population convergence in the kth iteration, IDₙ(k) is individual diversity of the nth particle in the kth iteration, PD(k) is population diversity in the kth iteration, u∈[k−k₀, k] is iteration times;
III. select evolutionary strategy of population:
Case 1: when PC(k)>PC(k−1) and PD(k)>PD(k−1), velocity and position of particle are updated by
v_{n,d}(k+1)=ωv_{n,d}(k)+c₁r₁(p_{n,d}(k)−x_{n,d}(k))+c₂r₂(g_{d}(k)−x_{i,d}(k)) (14)
x_{n,d}(k+1)=x_{n,d}(k)+v_{n,d}(k+1) (15)
where ω is inertia weight selected in [0.5, 0.9] randomly, v_{n,d}(k) is d-dimensional velocity of the nth particle in the kth iteration, x_{n,d}(k) is d-dimensional position of the nth particle in the kth iteration, p_{n,d}(k) is d-dimensional personal best position of the nth particle in the kth iteration, g_{d}(k) is d-dimensional position of the population in the kth iteration, r₁ and r₂ are a random value distributed in [0, 1], c₁ is an acceleration factor of personal best solution, selected in [1.5, 2.5] randomly, c₂ is an acceleration factor of global best solution, selected in [1.5, 2.5] randomly;
Case 2: when PC(k)<PC(k−1) and PD(k)>PD(k−1), the velocity and position of particle are updated by
v_{n,d}(k+1)=ωv_{n,d}(k)+c₁r₁(p_{n,d}(k)−x_{n,d}(k))+c₂r₂(g_{d}(k)−x_{i,d}(k))+c₃r₃C_{d}(k) (16)
x_{n,d}(k+1)=x_{n,d}(k)+v_{n,d}(k+1) (17)
where r₃ is a random value distributed in [0, 1], c₃ is an acceleration factor related to convergence direction, selected in [0.3, 0.5] randomly, C_{d}(k) is d-dimensional flight direction of particles with maximum convergence in the population;
Case 3: when PC(k)>PC(k−1) and PD(k)<PD(k−1), the velocity and position of particle are updated by
v_{n,d}(k+1)=ωv_{n,d}(k)+c₁r₁(p_{n,d}(k)−x_{n,d}(k))+c₂r₂(g_{d}(k)−x_{i,d}(k))+c₄r₄D_{d}(k) (18)
x_{n,d}(k+1)=x_{n,d}(k)+v_{n,d}(k+1) (19)
where r₄ is a random value distributed in [0, 1], c₄ is an acceleration factor related to diversity direction, selected in [0.3, 0.5] randomly, D_{d}(k) is d-dimensional flight direction of particles with maximum diversity in the population;
Case 4: when PC(k)<PC(k−1) and PD(k)<PD(k−1), the velocity and position of particle are updated by
v_{n,d}(k+1)=ωv_{n,d}(k)+c₁r₁(p_{n,d}(k)−x_{n,d}(k))+c₂r₂(g_{d}(k)−x_{i,d}(k))+½(c₃r₃C_{d}(k)+c₄r₄D_{d}(k)) (20)
x_{n,d}(k+1)=x_{n,d}(k)+v_{n,d}(k+1) (21)
Case 5: when PC(k)=PC(k−1) or PD(k)=PD(k−1), the velocity and position of particle are updated by
$$\begin{matrix}{v}_{n , d} ( k + 1 ) = ω {v}_{n , d} ( k ) + {c}_{1} {r}_{1} ( {p}_{n , d} ( k ) - {x}_{n , d} ( k ) ) + {c}_{2} {r}_{2} ( {g}_{d} ( k ) - {x}_{i , d} ( k ) ) & ( 22 ) \\ {x}_{n , d} ( k + 1 ) = \{ \begin{matrix}{x}_{d , min} + ( {x}_{d , max} - {x}_{d , min} ) \times U ( 0 , 1 ) , & {r}_{5} \leq {p}_{b} \\ {x}_{n , d} ( k ) , & {r}_{5} > {p}_{b}\end{matrix} & ( 23 )\end{matrix}$$
where U(0, 1) is a random value between 0 and 1 which obeys uniform distribution, x_{d,min} is a minimum boundary value of d-dimensional position, x_{d,max} is a maximum boundary value of d-dimensional position; when d=1, x_{1,min}=0.2 mg/L, x_{1,max}=2 mg/L; when d=2, x_{2,min}=0.4 mg/L, x_{2,max}=3 mg/L; r₅ is a random value distributed in [0, 1], p_{b} is mutation probability, which is described as
$${p}_{b} = 0.5 - 0.5 \times \frac{k}{K} \qquad ( 24 )$$
IV. population in the kth iteration is combined with archive A(k−1) to obtain J(k), and then the non-dominated solutions are selected from J(k) to establish A(k);
V. if k is greater than or equal to K, go to step VI; if k is less than K, go to step I;
VI. in the archive A(K), a non-dominated solution is randomly selected as an optimal set-point a*(t)=aₕ(K), aₕ(K)=[S_{NO}*(K), S_{O}*(K)], where S_{NO}*(K) is an optimal set-point of S_{NO}, S_{O}*(K) is an optimal set-point of S_{O}; then, the optimal set-points are saved;
(3) track the optimal set-points S_{NO}*(K) and S_{O}*(K):
PID controller is designed to track the optimal set-points S_{NO}*(K) and S_{O}*(K); the expression of PID controller is
$$\begin{matrix}Δ z ( t ) = {K}_{p} [ e ( t ) + {H}_{l} {\int }_{0}^{t} e ( t ) d t + {H}_{d} \frac{d e ( t )}{d t} ] & ( 25 ) \\ {K}_{p} = [ \begin{matrix}10000 & 0 \\ 0 & 20\end{matrix} ] & ( 26 ) \\ {H}_{l} = [ \begin{matrix}3000 & 0 \\ 0 & 5\end{matrix} ] & ( 27 ) \\ {H}_{d} = [ \begin{matrix}100 & 0 \\ 0 & 1\end{matrix} ] & ( 28 )\end{matrix}$$
where Δz(t)=[ΔQₐ(t), ΔK_{La}5(t)]^{T} is a manipulated variable matrix, ΔQₐ(t) is a change of internal circulation flow in wastewater treatment process, ΔK_{La}5(t) is a change of oxygen transfer coefficient in a fifth zone of biochemical reactor, Kₚ is a proportional coefficient matrix, Hₗ is an integral coefficient matrix, and H_{d} is a differential coefficient matrix; e(t)=y*(t)^{T}−y(t)^{T} is a control error, y*(t)=[S_{NO}*(t), S_{O}*(t)] is an optimal set-point matrix at time t, y(t)=[S_{NO}(t), S_{O}(t)] is an actual output matrix;
(4) inputs of the data-knowledge driven optimal control method of municipal wastewater treatment process are the change of internal circulation flow ΔQₐ(t) and the change of oxygen transfer coefficient in the fifth zone of biochemical reactor ΔK_{La}5(t); the optimal set-points of S_{NO} and S_{O} in municipal wastewater treatment process are tracked and controlled.
